(19) United States
(12) Patent Application Publication
(10) Pub. No.: US 2009/0102393 A1
(43) Pub. Date: Apr. 23, 2009

(54) Circuit Arrangement for Operation of a Discharge Lamp with a Switchable Tuned Capacitor

(75) Inventor: Klaus Fischer, Friedberg (DE)

Correspondence Address: Viering, Jentschura & Partner - OSR, 3770 Highland Ave., Suite 203, Manhattan Beach, CA, 90266, US

(73) Assignee: Patent-Treuhand-Gesellschaft Fur Elektrische Gluhlampen MBH, Munchen (DE)

(21) Appl. No.: 11/920,645

(22) PCT Filed: May 15, 2006
(86) PCT No.: PCT/DE2006/000833

§ 371 Date: Nov. 19, 2007

(30) Foreign Application Priority Data
May 17, 2005 (DE) 10 2005 022 592.6

(51) Int. Cl. H05B 41/36; H05B 41/295

(52) U.S. Cl. 315/291

(57) ABSTRACT

The invention relates to a circuit arrangement for operation of a discharge lamp (EL) with an inverter (INV) which generates a high-frequency alternating current from an input voltage and with a tuned circuit provided with at least one choke (L) and at least one tuned capacitor (C3, C4), by means of which the lamp (EL) is supplied, whereby at least one tuned capacitor (C4) is connected in series with a switch element (T1) parallel to the lamp (EL). The resonance capacitance for control of the lamp can be varied by switching in or out the tuned capacitor. For example, the resonance capacitance can be increased for pre-heating and reduced on lamp operation.

### TECHNICAL FIELD

The invention relates to a circuit arrangement for operating a discharge lamp in accordance with the precharacterizing clause of patent claim 1.

### PRIOR ART

All electronic ballasts which are conventional today for low-pressure discharge lamps use a resonant circuit, which is formed from a current-limiting inductor, a coupling capacitor and a resonant capacitor, which is connected in parallel with the gas discharge path, to ignite the gas discharge and for the subsequent operation of the lamp. Since the coupling capacitor is very large in comparison with the resonant capacitor, the resonant frequency of the resonant circuit is substantially determined by the inductance and by the capacitance of the resonant capacitor.

The resonant circuit is supplied with energy by an inverter, which converts a rectified and smoothed supply voltage into a high-frequency AC voltage.

The resonant capacitor is connected to the lamp in such a way that, before the gas discharge is ignited, the current flowing via the resonant capacitor flows via the two filaments, as a result of which said filaments can be preheated to a temperature capable of emission.

In order to ignite the lamp, the frequency of the inverter is brought close to the resonant frequency of the resonant circuit using suitable measures. As a result, high voltages are produced via the resonant capacitor and therefore via the lamp and the gas discharge is reignited.

For optimum preheating of the filament before the lamp is ignited, sufficient current needs to flow via the resonant capacitor, in which case the voltage across the resonant capacitor needs to be limited.

Particularly in the case of lamps with a relatively low ignition voltage, it is therefore advantageous if a high resonant capacitance is provided for the purpose of preheating.

The resonant capacitance cannot be selected to be as large as desired, however.

During operation of the lamp, the inductance in the resonant circuit is used for limiting the lamp current, and the capacitance of the resonant capacitor, in parallel with the lamp, injects a reactive current into the inductor in addition to the active current flowing in the lamp. During operation, overload of or damage to the lamp filaments may result if the sum of the active current through the lamp and the reactive current, which flows via the resonant capacitor, is too high. In this regard it would be advantageous if the capacitance of the resonant capacitor is not too high for the operation of the lamp.

### DESCRIPTION OF THE INVENTION

The object of the present invention is to improve a circuit arrangement for operating a discharge lamp in accordance with the precharacterizing clause of patent claim 1 in such a way that the effective capacitance of the resonant capacitor in parallel with the lamp is selected optimally.

In order to achieve the object, in accordance with the invention at least one resonant capacitor is connected in series with a switching element and in parallel with the lamp.

This makes it possible to connect the resonant capacitor in the preheating phase via the switching element and to disconnect it during operation of the lamp.

The advantage of the invention is therefore that both the requirement of a high resonant capacitance in the preheating phase and a lower resonant capacitance during operation can be met.

In accordance with a preferred embodiment of the invention, a resonant capacitor is connected in parallel with the lamp, which resonant capacitor is not in series with a switching element, and a resonant capacitor which is in series with a switching element.

Therefore not the entire resonant capacitance is disconnected or connected by means of the switching element, but the resonant capacitance is correspondingly decreased and increased in value.

This embodiment is in particular also advantageous in the case of dimmable lamps. In the case of dimmable lamps, the luminous flux of the lamp can be set by varying the frequency of the inverter. The complex impedance of the resonant capacitor decreases in value as the frequency increases. As a result, the no-load voltage of the ballast which can be achieved and therefore the maximum usable operating voltage is limited. The greater the value of the resonant capacitor is selected to be, the lower the achievable no-load voltage becomes. In this case it is possible, not only during the heating but also during full-load operation for providing a sufficient reactive current, to make available a high resonant capacitance, this resonant capacitance then being disconnected via the switching element if a reduction in the luminous flux is desired for the purpose of dimming, with the result that high lamp voltages can be produced at low lamp currents.

In a preferred embodiment, the switching element is a transistor, in particular a MOSFET. It is a common switching element.

In order to protect the transistor, it may be necessary to limit the maximum control voltage at the transistor. For this purpose, in a preferred embodiment the cathode of a Zener diode is connected to a control connection of the transistor, and its anode is connected to a reference potential for the control voltage of the transistor.

It is also part of a preferred embodiment that the discharge lamp has filaments which can be heated by current. The resonant capacitor is then preferably connected up in such a way that the current flowing via the switchable resonant capacitor flows at least partially through the lamp filaments.

In order in this case to ensure that substantially the same amount of current flows via the two filaments, the filaments are bridged by diodes. The anode of a first diode is connected to a connection of the switchable resonant capacitor, and the anode of a second diode is connected to a connection of the switching element, in the case of a transistor to a reference potential for the control voltage. The cathodes of both diodes are connected to the inverter-side connections of the filaments.

In the case of a switching element such as a transistor, the switching element needs to be protected against excessively high voltages. In the event of the reverse voltage being exceeded, a voltage breakdown may occur.

In order to protect the switching element, a further diode is preferably provided, whose cathode is connected to a positive supply potential of the inverter and whose anode is connected to the switching element.

In the event of the transistor being turned off, this diode limits the maximum voltage value present at the transistor to the value of the supply voltage.

### BRIEF DESCRIPTION OF THE DRAWINGS

The invention will be explained in more detail below with reference to a plurality of exemplary embodiments. In the drawings:

FIG. 1 shows a circuit diagram of a circuit arrangement for operating a discharge lamp in accordance with a first embodiment of the invention,

FIG. 2 shows a circuit diagram of a circuit arrangement for operating a discharge lamp in accordance with a second embodiment of the invention, and

FIG. 3 shows a circuit diagram of a circuit arrangement for operating a discharge lamp in accordance with a third embodiment of the invention.

### PREFERRED EMBODIMENT OF THE INVENTION

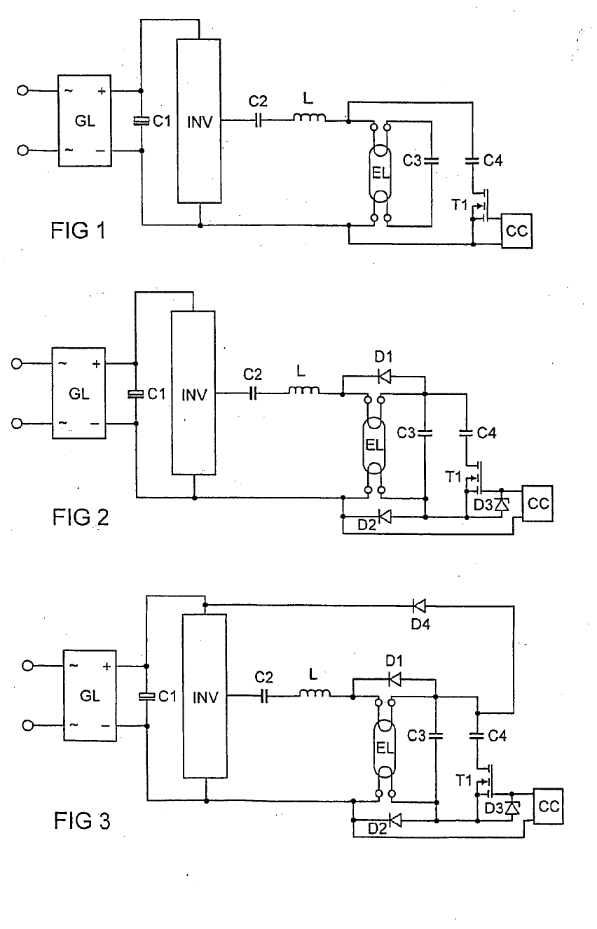

FIG. 1 illustrates a circuit arrangement in accordance with a first embodiment of the invention. The system voltage is rectified via a rectifier GL and smoothed with a capacitor C1. An inverter, which does not need to be described in any further detail here, converts the rectified and smoothed supply voltage into a high-frequency AC voltage.

Downstream of the inverter there is formed a resonant circuit, which comprises a coupling capacitor C2, a current-limiting inductor L and two resonant capacitors C3 and C4, the resonant capacitor C4 being connected in series with a switching element T1 and in parallel with the lamp EL. The switching element can be switched via a control circuit CC.

The switching element T1 is illustrated here as an MOS transistor.

The transistor T1 is switched on during a preheating and ignition phase, as a result of which the capacitor is electrically effective in parallel with the lamp.

Once the lamp has been ignited, the transistor can be switched off so as to reduce the electrically effective resonant capacitance. In this case, the disconnected resonant capacitor is charged once to the peak value of the operating voltage, but is not charged any more as a result of the switched-off transistor and therefore remains electrically passive.

For this reason, the breakdown voltage of the transistor needs to be selected such that it is at least twice as great as the peak value of the operating voltage in order that a voltage breakdown does not occur even in the case of a half-cycle in the resonant circuit in the opposite direction.

In the arrangement shown in FIG. 1, the capacitance of the switchable resonant capacitor C4 is not used for heating filaments of the lamp.

FIG. 2 now shows an embodiment in which the switchable resonant capacitor is connected to the lamp on the heating-circuit side. Two diodes D1 and D2 are provided whose cathodes are connected to the inverter-side connections of the filaments. The anode of the first diode D1 is connected to a connection of the connectable resonant capacitor. The anode of the second diode D2 is connected to the reference potential for the control voltage of the transistor T1.

The control voltage of the control circuit CC, which in this case controls the transistor T1, is generally related to the negative potential of the overall circuit. A positive voltage drop across the lamp filament connected to this negative potential needs to be suppressed. This would result in the transistor T1 being switched off since there would not be sufficient control voltage available at the output of CC. For this reason, the diode D2 bridges the filament such that the positive voltage drop across the filament can at a maximum assume the level of the forward voltage of the diode. The control voltage at which the control circuit CC switches the transistor on therefore then only needs to be as great as the sum of the forward voltage of the diode D2 and the threshold voltage of the transistor T1 used.

In the case of the reverse polarity of the voltage drop across the filament if the diode D2 is off, the potential of the anode of the diode D2 and of the connection of transistor T1 connected thereto falls below the negative supply potential of the overall circuit. In this phase, the body diode always provided in the case of an MOS transistor passes the current through the switchable resonant capacitor C4. The transistor T1 therefore does not need to be switched on, rather it is only necessary for the maximum control voltage to be limited corresponding to the load capacity of the component. For this purpose, a Zener diode D3 is provided, whose cathode is connected to the control connection of the transistor and whose anode is connected to the reference potential for the control voltage of the transistor.

The bridging of the lamp filament, which is connected directly to the switchable resonant capacitance, with a diode D1 is used for balancing reasons. The polarization of this diode is such that, in each half-cycle of the current through the inductance, the current which flows via C3 and C4 flows through in each case one of the two filaments, while this current is guided past the other filament via the respective diode D1 or D2 in parallel.

As described above, the capacitor C4 in the disconnected state, i.e. if the transistor T1 has not been switched on, is charged to the negative peak value of the lamp operating voltage on the heating-circuit side and remains in this state during further operation until the transistor T1 is switched on again.

Particularly in the case of lamps with a large discharge lamp, high operating voltages can occur at a reduced lamp current. As a result of the voltage at the capacitor C4 when the transistor is switched off, the required dielectric strength of the transistor T1 is very great.

For this reason, the embodiment shown in FIG. 3 is proposed.

The embodiment shown in FIG. 3 differs from that shown in FIG. 2 by virtue of the fact that a diode D4 is provided which is connected on the cathode side to the positive supply potential of the inverter, i.e. to the positive voltage side of the voltage source GL, with its anode being connected to the switching element.

In the event of T1 being turned off, the diode D4 limits the maximum voltage value present at T1 to the value present at C1, i.e. to the instantaneous value of the supply voltage of the inverter.

In the case of all three embodiments described with respect to FIGS. 1 to 3, a control circuit CC interacts with the inverter INV. The switching-on of the transistor T1 and therefore the connection of the capacitance C4 can take place in particular during preheating of the filaments, but also in the context of complex control of the operation of the lamp for example in the event of full load while the transistor T1, on the other hand, is then switched off when the lamp is dimmed.

1. A circuit arrangement for operating a discharge lamp (EL), in particular a low-pressure discharge lamp, with an inverter (INV), which produces a high-frequency AC voltage from an input voltage (GL, C1), with a resonant circuit (C2, L, C3, C4), which comprises at least one inductor (L) and at least one resonant capacitor (C3, C4), via which the lamp is supplied, characterized in that at least one resonant capacitor (C4) is connected in series with a switching element (T1) and in parallel with the lamp (EL).

2. The circuit arrangement as claimed in claim 1, characterized in that the switching element is a transistor (T1), preferably a MOSFET.

3. The circuit arrangement as claimed in claim 2, characterized in that the cathode of a Zener diode (D3) is connected to a control connection of the transistor and its anode is connected to a reference potential for the control voltage of the transistor.

4. The circuit arrangement as claimed in claim 1, characterized in that the discharge lamp (EL) has filaments which can be heated by current, and in that the current flows at least partially through the lamp filaments via the switchable resonant capacitor (C4).

5. The circuit arrangement as claimed in claim 4, characterized in that the lamp filaments are bridged by diodes (D1, D2) in such a way that the anode of a first diode (D1) is connected to a connection of the switchable resonant capacitor, and the anode of a second diode (D2) is connected to a connection of the switching element (T1), and the cathodes of both diodes (D1, D2) are connected to inverter-side connections of the filaments.

6. The circuit arrangement as claimed in claim 1, characterized in that the cathode of a diode (D4) is connected to a positive supply potential of the inverter (INV) and its anode is connected to the switching element (T1).

7. The circuit arrangement as claimed in claim 2, characterized in that the discharge lamp (EL) has filaments which can be heated by current, and in that the current flows at least partially through the lamp filaments via the switchable resonant capacitor (C4).

8. The circuit arrangement as claimed in claim 3, characterized in that the discharge lamp (EL) has filaments which can be heated by current, and in that the current flows at least partially through the lamp filaments via the switchable resonant capacitor (C4).

9. The circuit arrangement as claimed in claim 2, characterized in that the cathode of a diode (D4) is connected to a positive supply potential of the inverter (INV) and its anode is connected to the switching element (T1).

10. The circuit arrangement as claimed in claim 3, characterized in that the cathode of a diode (D4) is connected to a positive supply potential of the inverter (INV) and its anode is connected to the switching element (T1).

11. The circuit arrangement as claimed in claim 4, characterized in that the cathode of a diode (D4) is connected to a positive supply potential of the inverter (INV) and its anode is connected to the switching element (T1).

12. The circuit arrangement as claimed in claim 5, characterized in that the cathode of a diode (D4) is connected to a positive supply potential of the inverter (INV) and its anode is connected to the switching element (T1).
